(19) United States
(12) Patent Application Publication
(10) Pub. No.: US 2014/0182175 A1
(43) Pub. Date: Jul. 3, 2014

(54) FOLDER WITH MULTIPLE DIVIDERS

(71) Applicant: Peter Rigas, Yardley, PA (US)

(72) Inventor: Peter Rigas, Yardley, PA (US)

(21) Appl. No.: 14/142,495

(22) Filed: Dec. 27, 2013

Related U.S. Application Data
(60) Provisional application No. 61/746,798, filed on Dec. 28, 2012.

(51) Int. Cl. B42F 7/06

(52) U.S. Cl. CPC B42F 7/06
USPC 40/359; 83/13; 229/67.1

(57) ABSTRACT

A folder with multiple dividers is provided. The folder may include a first cover and a second cover, each having a top end, a bottom end, an open side and a closed side. The first cover and the second cover may meet at the closed side. At least one cutout portion may run from the top end to the closed side of at least one of the first cover and second cover. The cutout portion may create a plurality of dividers so that a user may organize paperwork within them.

### CROSS-REFERENCE TO RELATED APPLICATION

This application claims the benefit of priority of U.S. provisional application No. 61/746,798, filed Dec. 28, 2012, the contents of which are herein incorporated by reference.

### BACKGROUND OF THE INVENTION

The present invention relates to a folder and, more particularly, to a multi-tab folder.

Currently, when users store paperwork, a folder without any tabs or a binder with multiple tabs must be used. If there is a lot of paperwork, the user may need to separate the paperwork into categories. This would either require the user to purchase multiple folders, or use the binder mentioned above. Binders are big and bulky, and if there are not many subcategories needed than the binder is not completely utilized and therefore a waste of space.

As can be seen, there is a need for a slim folder that categorizes paperwork.

### SUMMARY OF THE INVENTION

In one aspect of the present invention, an organizing device comprises: a folder comprising at least a first cover and a second cover each comprising a top end, a bottom end, an open side, and a closed side, wherein the first cover and the second cover are connected together at the closed side; at least one cutout portion on at least one of the first cover and the second cover, wherein the cutout portion extends from the top end to the closed side, wherein the cutout portion forms a plurality of dividers comprising at least a first divider and a second divider.

In another aspect of the present invention, a method of creating an organizing device comprises: providing a folder comprising at least a first cover and a second cover each comprising a top end, a bottom end, an open side, and a closed side, wherein the first cover and the second cover are connected together at the closed side by a crease; and cutting a cutout portion forming a divider in at least one of the first cover and the second cover, wherein the cutout portion is a line from the top end to the closed side.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is an exploded view of the present invention demonstrating insertion of exemplary documents;

FIG. 3 is a perspective view of the present invention demonstrating placement of exemplary documents;

FIG. 4 is a front view of an embodiment of the present invention;

FIG. 5 is a rear view of an embodiment of the present invention;

FIG. 6 is a rear view of an embodiment of the present invention; and

FIG. 7 is a front view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include a folder which may have added tabs that may be used as mini sub folders to sub-divide paperwork. The present invention may eliminate the need for additional folders, bulkiness, and costs by reducing the amount of material needed. In certain embodiments, perforations and/or slits may be provided to simplify sub-dividing the paperwork. The integrated self dividing folder may give the user flexibility to use the folder with or without sub-divided folders which may have their own tabs. The sub-tabs may be easy to read and a user may access the desired documents instantly without fumbling through piles of papers. The folder may open similar to a book or magazine without needing to remove documents from restrictive pockets.

Broadly, an embodiment of the present invention provides a folder with multiple dividers. The folder may include a first cover and a second cover, each having a top end, a bottom end, an open side and a closed side. The first cover and the second cover may meet at the closed side. At least one cutout portion may run from the top end to the closed side of at least one of the first cover and second cover. The cutout portion may create a plurality of dividers so that a user may organize paperwork within them.

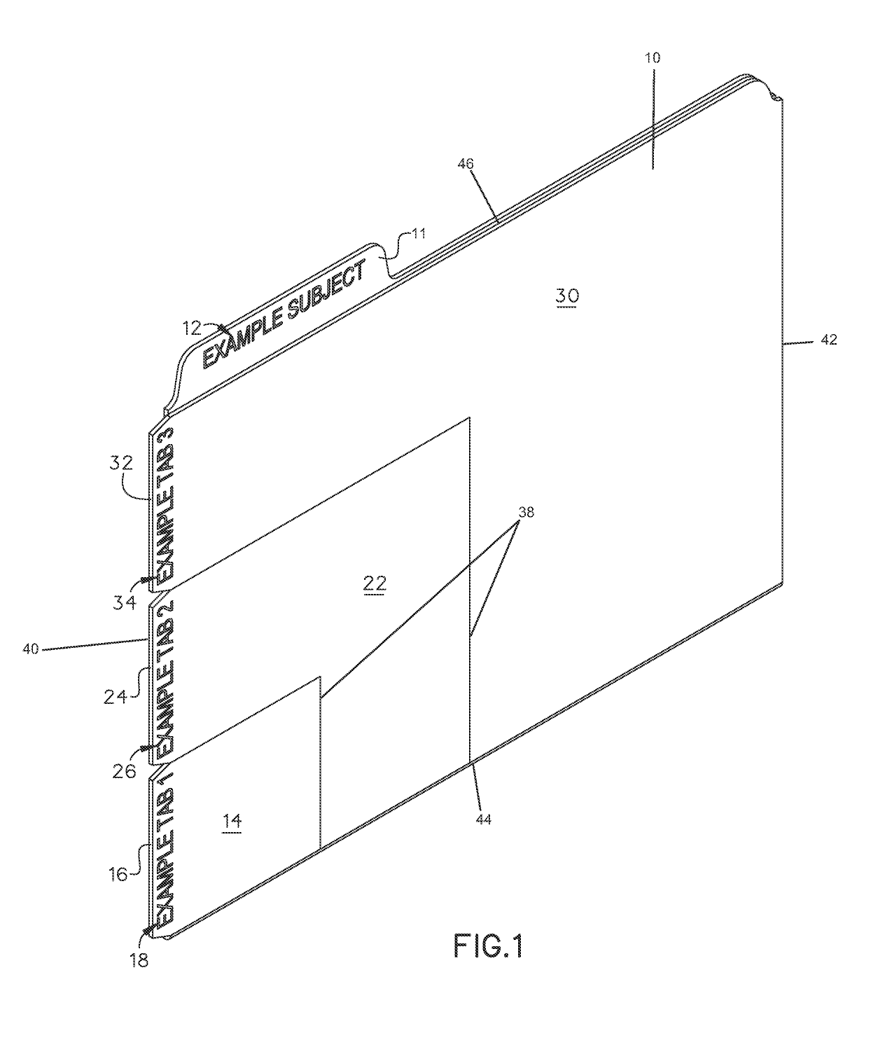

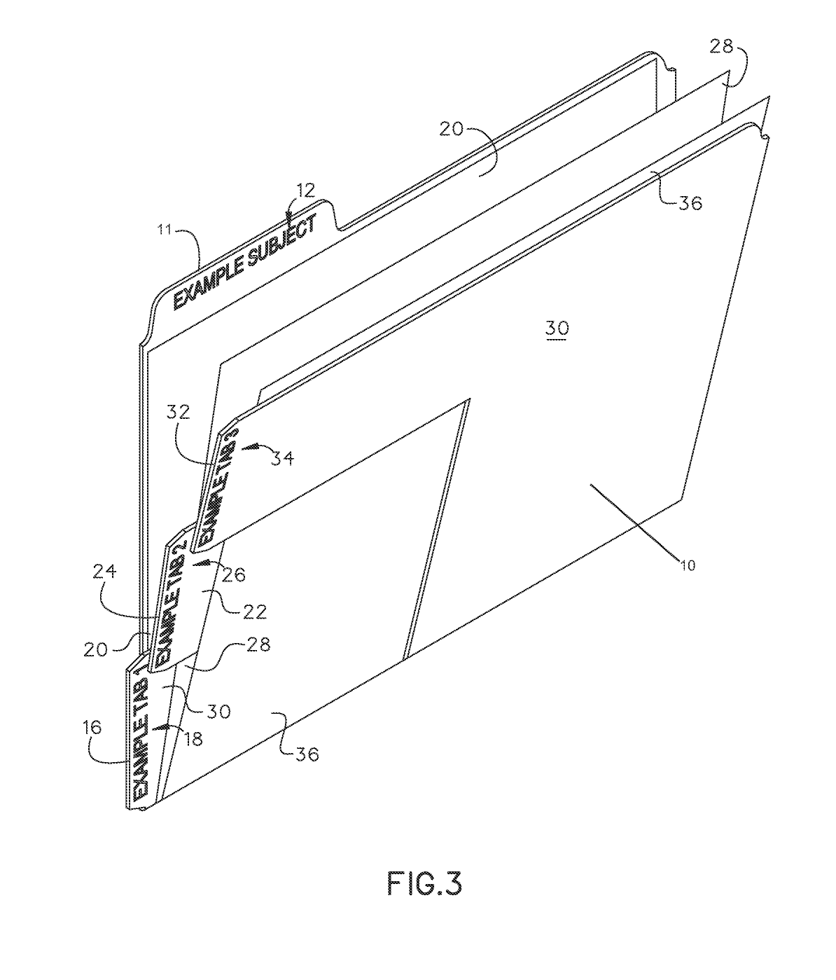

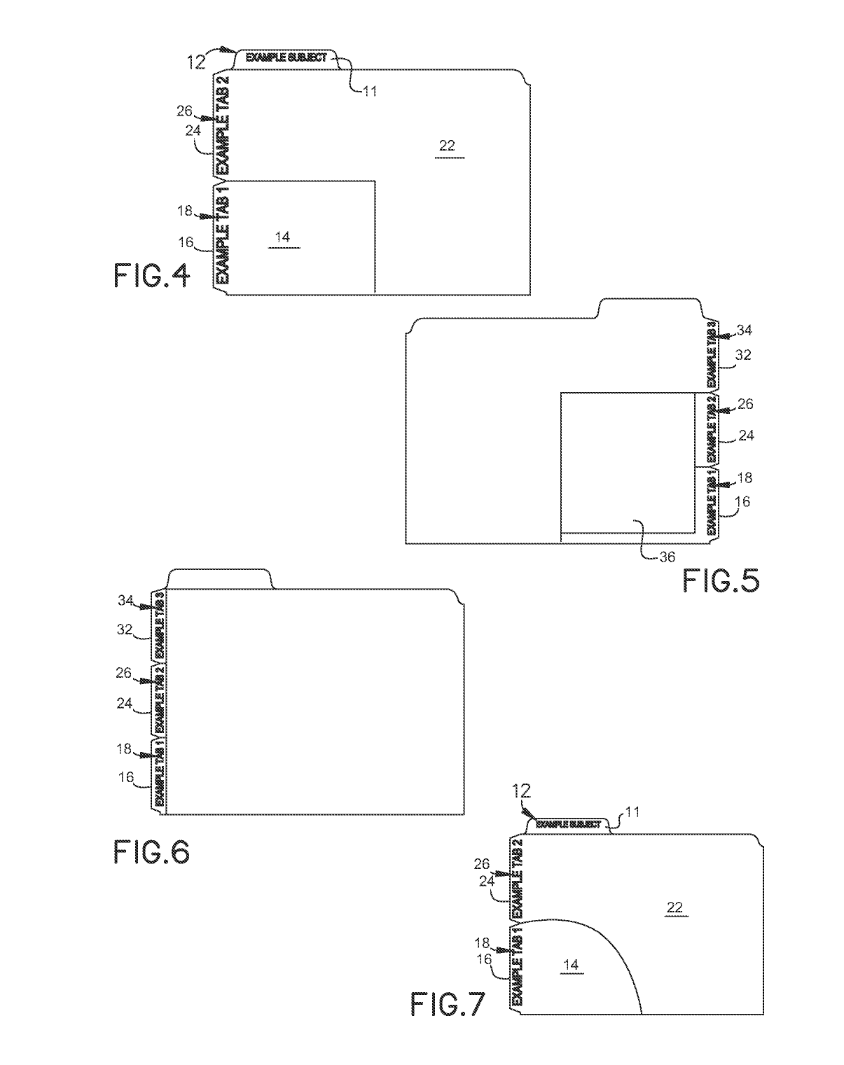

Referring to FIGS. 1 through 7, present invention may include a multi-tab folder 10. The folder 10 may be a regular paper based folder, i.e. a paper sheet that may be folded over at a crease. The folder 10 may include at least a first cover 48 and a second cover 50. Each of the first and second covers 48, 50 may include a top end 40, a bottom end 42, an open side 46, and a closed side 44. The first cover 48 and the second cover 50 are joined together at the closed side 44. At least one of the first and second covers 48, 50 may include at least one cutout portion 38. The cutout portion 38 extends from the top end 40 to the closed side 44. The cutout portion 38 forms a plurality of dividers 14, 22, 30 having at least a first divider 14 and a second divider 22.

The cutout portion 38 may be made of a straight or a curved line. In certain embodiments, the cutout portion 38 may be a separation between the dividers 14, 22, 30, such as the separation between the first divider 14, the second divider 22 and a third divider 30. In certain embodiments, the cutout portions 38 may include designations that indicate where the dividers 14, 22, 30 are to be separated. Therefore, in such embodiments, the first cover 48 and the second cover 48 may be still intact. The designations may include a printed line or a perforation. Therefore, a user may either cut the printed line or rip the perforations to create the plurality of dividers 14, 22, 30.

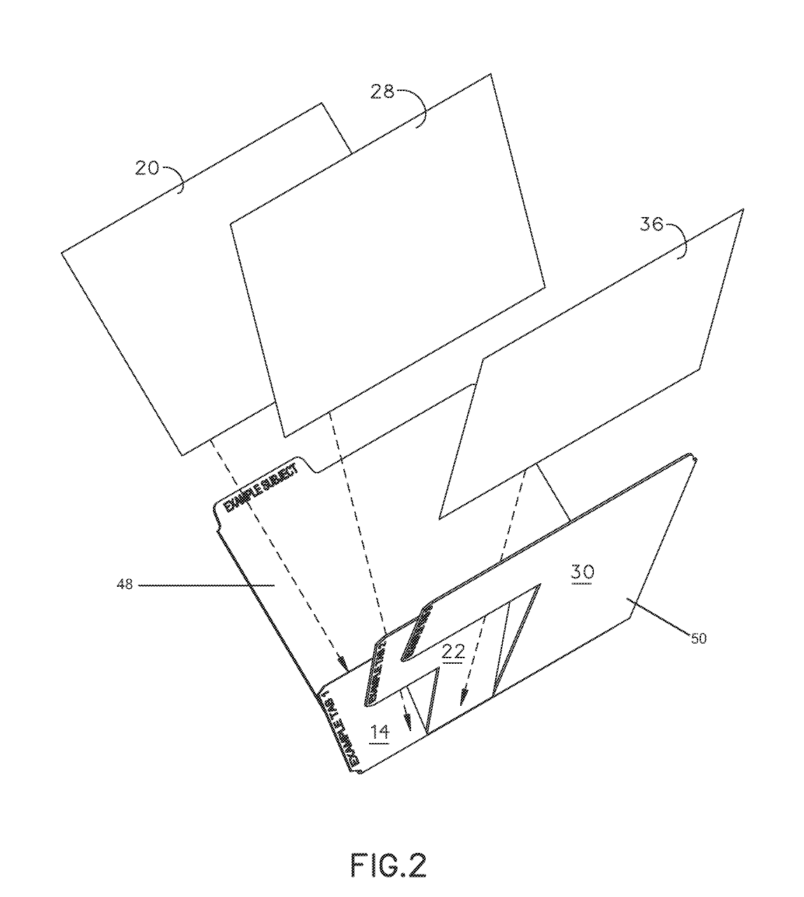

As illustrated in the Figures, the folder 10 of the present invention may include a plurality of cutout portions 38. In such embodiments, the cutout portions 38 may still run from the top end 40 to the closed side 44. However, the cutout portions 38 do not overlap and therefore create a plurality of dividers 14, 22, 30. As illustrated in FIG. 2, the first cutout portion 38 may form a first divider 14 and a second divider 22, and the second cutout portion 38 may from the third divider 30. In certain embodiments, the first and second cover 48, 50 may both include cutout portions 38 and therefore providing for a plurality of dividers 14, 22, 30 on each cover 48, 50.

In certain embodiments, each divider 14, 22, 30 and at least one of the covers 48, 50 may include a tab 16, 24, 32 with which may be written on. As illustrated in FIG. 1, the first divider 14 may include a first tab 16 with a first text region 18, the second divider 22 may include a second tab 24 with a second text region 26, and the third divider 30 may include a third tab 32 with a third text region 34. The tabs 16, 24, 32, may extend from the top end 40 of the folder 10. In such embodiments, the first cover 48 may also include a tab 11 with a text region 12. The text regions 12, 18, 26, 32 may indicate what documents are within each divider 14, 22, 30. For example, the subject matter of a first document 20 may be indicated on the first text region 18, the subject matter of a second document 28 may be indicated on the second text region 26, and the subject matter of a third document 36 may be indicated on the third text region 32.

A method of creating an organizing device may include the following: providing a folder comprising at least a first cover and a second cover each comprising a top end, a bottom end, an open side, and a closed side, wherein the first cover and the second cover are connected together at the closed side by a crease; cutting a cutout portion forming a divider in at least one of the first cover and the second cover, wherein the cutout portion is a line from the top end to the closed side.

A method of making the folder may include the following. The current normal manufacturing process may be used to create standard file folders with the top tab folder, end tab folders, right or left side tab folders, or hanging folders. Additional die-cutting may be used to add the desired number of sub-tabs to the front panel or the rear panel. Adding perforations and/or slits to form additional sub-folders to the front or rear panels may be added. Adding outline to outline sections in the front or rear cover or both may also be done.

The following alternative embodiments may also be included as embodiments of the present invention. The sub tabs may optionally create at least one additional divider with-in a folder. The sub-tabs may be side tabs with the side tab folder. The sub-tabs may be top tabs with the side tab folder. The sub-tabs may be side tabs with the top tab folder. The sub-tabs may be top tabs with the top tab folder. In certain embodiments, sub-tabs may on be front cover or rear cover. In certain embodiments the primary tab may be the front cover or the rear cover.

The present invention may also be used like a normal single folder in its un-cut form. When a subject needs multi-subject or has multi-subject needs at the outset, the folder may be cut along the outline or ripped along perforations to create multi-subject sections, like book marks. For example, if the primary subject is “Auto” on the primary tab, the sub tabs can be labeled “repairs” and “insurance”. When folder is closed the user may be able to read exposed sub tabs and access the sub topic desired without opening and fumbling through piles of papers. This also eliminates the need to have one folder for each sub category.

The multi tab folder may be utilized in digital applications such as computers, laptops, smart devices and the like. The multi tab folder may be used in software applications, such as proprietary or open source. The digital folder may have the appearance of the physical version described above. The folder may be on a user's computer “desktop”, for example in its current form or when expanded or needed to expand, perforations or lines will show indicating multiple sub folders exist. A digital version may also be, for example, instantly available to grab as an option from the start in a drop down menu.

It should be understood, of course, that the foregoing relates to exemplary embodiments of the invention and that modifications may be made without departing from the spirit and scope of the invention as set forth in the following claims.

What is claimed is:

1. An organizing device comprising:
a folder comprising at least a first cover and a second cover each comprising a top end, a bottom end, an open side, and a closed side, wherein the first cover and the second cover are connected together at the closed side;
at least one cutout portion on at least one of the first cover and the second cover, wherein the cutout portion extends from the top end to the closed side,
wherein the cutout portion forms a plurality of dividers comprising at least a first divider and a second divider.

2. The organizing device of claim 1, wherein the cutout portion forms a separation between the first divider and the second divider

3. The organizing device of claim 1, wherein the cutout portion comprises a designation indicating a separation to be made.

4. The organizing device of claim 3, wherein the designation is at least one of a perforation and a printed line.

5. The organizing device of claim 1, wherein the at least one cutout portion comprises a first cutout portion and a second cutout portion, wherein the first cutout portion extends from the top end to the closed side and the second cutout portion extends from the top end to the closed side, wherein the first cutout portion and the second cutout portion do not overlap.

6. The organizing device of claim 1, wherein the first cover and the second cover each comprise a cutout portion.

7. The organizing device of claim 1, wherein at least one of the first cover and the second cover comprises a plurality of cutout portions, wherein the cutout portions do not overlap.

8. The organizing device of claim 1, wherein at least the first cover comprises a text tab extending from the open side and the plurality of dividers are formed on the second cover, wherein each of the plurality of dividers comprise a text tab extending from the top end.

9. The organizing device of claim 1, wherein the folder is selected from the group consisting of top tab folders, end tab folders and hanging folders.

10. A method of creating an organizing device comprising:
providing a folder comprising at least a first cover and a second cover each comprising a top end, a bottom end, an open side, and a closed side, wherein the first cover and the second cover are connected together at the closed side by a crease; and
cutting a cutout portion forming a divider in at least one of the first cover and the second cover, wherein the cutout portion is a line from the top end to the closed side.
